(19) United States
(12) Patent Application Publication
(10) Pub. No.: US 2018/0231213 A1
(43) Pub. Date: Aug. 16, 2018

(54) LIGHT EMITTING UNIT AND LIGHT SOURCE UNIT COMPRISING SAME

(71) Applicant: LG INNOTEK CO., LTD., Seoul (KR)

(72) Inventor: Sung Ku KANG, Seoul (KR)

(73) Assignee: LG INNOTEK CO., LTD., Seoul (KR)

(21) Appl. No.: 15/580,802

(22) PCT Filed: Feb. 24, 2016
(86) PCT No.: PCT/KR2016/001774

§ 371 Date: Dec. 8, 2017

(30) Foreign Application Priority Data
Jun. 10, 2015 (KR) 10-2015-0081608

(51) Int. Cl. F21V 13/04; F21K 9/69; F21K 9/68; F21V 29/503; F21V 29/76

(52) U.S. Cl. CPC F21V 13/04; F21K 9/69; F21Y 2115/10; F21V 29/503; F21V 29/763; F21K 9/68

(57) ABSTRACT

An embodiment provides a light emitting unit comprising a refraction unit which is arranged on a body of the light emitting unit; a reflection unit which is arranged on the body so as to be spaced apart from the refraction unit; and a groove with at least a part thereof being arranged within the body and the refraction unit, wherein the height of the refraction unit is 1 to 2.5 times the height of the reflection unit, and the separation distance between the refraction unit and the reflection unit is shortest in the center of a region where the refraction unit and the reflection unit face each other, and largest at the edge.

### TECHNICAL FIELD

Embodiments relate to a light-emitting unit and a light source unit having the same, and more particularly, to a light-emitting unit, which emits most light in a given direction, and a light source unit having the same.

### BACKGROUND ART

Group III-V compound semiconductors such as, for example, GaN and AlGaN, are widely used for optoelectronics, electronic devices and the like, owing to many advantages such as, for example, a wide and easily adjustable band gap energy.

In particular, light-emitting devices such as light-emitting diodes or laser diodes using group III-V or II-VI compound semiconductors may realize various colors of light such as, for example, red, green, and blue light, as well as ultraviolet light, via the development of device materials and thin-film growth technique, and may also realize white light having high luminous efficacy via the use of a fluorescent material or by combining colors. These light-emitting devices have advantages of low power consumption, a semi-permanent lifespan, fast response speed, good safety, and eco-friendly properties compared to existing light sources such as, for example, fluorescent lamps and incandescent lamps.

Accordingly, the application of light-emitting devices has been expanded to a transmission module of an optical communication apparatus, a light-emitting diode backlight, which may substitute for a cold cathode fluorescent lamp (CCFL) constituting a backlight of a liquid crystal display (LCD) apparatus, a white light-emitting diode lighting apparatus, which may substitute for a fluorescent lamp or an incandescent bulb, a vehicle headlight, and a signal lamp.

A molded part may be disposed around a light-emitting device to protect, for example, a light-emitting structure or wires. Since light is refracted when passing through the molded part, which is formed of, for example, silicon, the molded part may serve as a primary lens.

However, when the light-emitting device is used as a light source of a lighting apparatus, a secondary lens may be used in order to adjust the path along which light is emitted. The aforementioned secondary lens is commonly referred to as a “lens”.

An optical path may be changed depending on the material of the lens and particularly on the shape thereof. In particular, in an application in which the light emitted from the light source needs to be directed in a specific direction such as, for example, forward or rearward, the shape of the lens is of increased importance.

### Technical Object

Embodiments are intended to concentrate, in a given direction, the quantity of light to be discharged outward in, for example, a lighting apparatus having a light source such as, for example, a light-emitting device.

### Technical Solution

One embodiment provides a light-emitting unit including a refractor disposed on a body, a reflector disposed on the body and spaced apart from the refractor, and a groove having at least a portion disposed inside the body and the refractor, wherein the refractor has a height ranging from 1 to 2.5 times a height of the reflector, and wherein the refractor and the reflector have a spacing therebetween, and the spacing has a smallest width at a center of an area in which the refractor and the reflector face each other and a largest width at an edge of the area.

The groove may include a first groove and a second groove above the first groove, and at least a portion of the first groove may be aligned with the refractor and the reflector.

The groove may include a first groove and a second groove above the first groove, and the second groove may be aligned with the refractor.

The groove may include a first groove and a second groove above the first groove, and a highest point of the refractor and a highest point of the second groove may be disposed with a central area of the refractor interposed therebetween.

The groove may have an upper surface, a portion of which forms a light introduction surface, and the light introduction surface may be a curved surface having at least two curvatures.

The refractor may have a surface including a curved surface, and the surface of the refractor may have a discontinuous line of curvature in an area thereof that faces the reflector.

The discontinuous line of curvature may be disposed in a height direction of the refractor.

The reflector may have a largest height in an area thereof that faces the discontinuous line.

The reflector may have a largest width in a central area thereof.

The reflector may have a largest height in a central area thereof.

The area may include an area disposed between the center and the edge thereof and having a spacing width that is greater than the width of the spacing at the center and is smaller than the width of the spacing at the edge.

The reflector may be formed of the same material as the refractor, and may have a convex and concave portion formed on a surface thereof in an area that faces the refractor.

The refractor and the reflector may have central areas respectively configured to protrude in the same direction.

At least one of the refractor and the reflector may be symmetrical about a center line of the refractor.

Another embodiment provides a light-emitting unit including a refractor disposed on a body, a reflector disposed on the body and spaced apart from the refractor, and a groove having at least a portion disposed inside the body and the refractor, wherein the refractor and the reflector have a spacing therebetween, and the spacing has a smallest width at a center of an area in which the refractor and the reflector face each other and a largest width at an edge of the area, and wherein the reflector includes a first surface facing the refractor and a second surface opposite the first surface, and the first surface and the second surface have different curvatures.

The reflector may include an area in which a width thereof increases and an area in which the width decreases between a central area and an edge area thereof.

A further embodiment provides an emission unit including the above-described light-emitting unit and a light-emitting device disposed in the groove.

Assuming that an angle between a z-axis orthogonal to an emission surface of the light-emitting device and light that proceeds from a surface of the refractor in a first direction is “α”, an angle between the z-axis and light that is discharged from the light-emitting device and proceeds in a second direction to thereby be introduced into the refractor from a surface of the groove is “δ”, an angle between the z-axis and light that is discharged from the light-emitting device and proceeds in the second direction to thereby be introduced into the refractor from the surface of the groove and thereafter be discharged from a surface of the refractor in the second direction is “ [symbol] ”, and an angle between the z-axis and light that is discharged in the second direction and reflected from the surface of the reflector to thereby proceed in the first direction is “β”, there is an equation of the form (n×cos α)−(n×cos β)>0.

In addition, there may be an equation of the form (n×cos [symbol] )−(n×cos β)>0.

In addition, there may be an equation of the form (n×cos δ)−(n×cos [symbol] )>0.

### Advantageous Effects

In a light-emitting unit and a light source unit having the same according to embodiments, the quantity of light proceeding in a second direction is much more than the quantity of light proceeding in a first direction. When the light-emitting unit and the light source unit are used, for example, in a lighting apparatus for roads, the quantity of light proceeding to houses may be reduced by setting the second direction to the direction toward the road and setting the first direction to the direction toward the houses.

### DESCRIPTION OF DRAWINGS

FIGS. 1a and 1b are plan views illustrating an embodiment of a light-emitting unit,

FIG. 2a is a perspective view illustrating the embodiment of the light-emitting unit,

FIG. 2b is a side view of the light-emitting unit in a first-axis direction,

FIG. 3 is a cross-sectional view of the light-emitting unit in a second-axis direction,

FIG. 4a is a view illustrating an embodiment of a light source module disposed in the light-emitting unit,

FIG. 4b is a view illustrating an embodiment of a light-emitting device of FIG. 4a,

FIG. 5 is a view illustrating the optical path of an emission unit,

FIG. 6 is a view illustrating the distribution of light emitted from the emission unit,

FIGS. 7a and 7b are views illustrating the measured results of back-side illuminance of the light emitted from the light-emitting unit,

FIGS. 8a and 8b are views illustrating the distribution of light emitted from a light source unit,

FIGS. 9a to 9c are views illustrating a light source unit in which the light-emitting unit described above is provided in a plural number, and

FIG. 10 is a view illustrating an embodiment of a lighting apparatus in which the light source unit described above is disposed.

### BEST MODE

Hereinafter, embodiments will be described in detail with reference to the accompanying drawings, in order to concretely realize the disclosure.

In the description of the embodiments, when an element is referred to as being formed “on” or “under” another element, it can be directly “on” or “under” the other element or be indirectly formed with intervening elements therebetween. It will also be understood that “on” or “under” the element may be described relative to the drawings.

A light-emitting unit according to the disclosure includes a body, a refractor disposed on the body, a reflector disposed on the body and spaced apart from the refractor, and a groove having at least a portion disposed inside the body and the refractor, wherein the refractor has a height ranging from 1 to 2.5 times a height of the reflector, and wherein the refractor and the reflector have a spacing therebetween, and the spacing has a smallest width at a center of an area in which the refractor and the reflector face each other and a largest width at an edge of the area.

The refractor may be formed of polycarbonate and may have an index of refraction ranging from 1.58 to 1.59. The reflector may be formed of the same material as the refractor and may be provided on a surface thereof with, for example, silver (Ag) or aluminum (Al) so as to reflect light, or may be provided with a convex and concave portion on a surface of an area thereof that faces the refractor so as to reflect light directed from the refractor.

Hereinafter, an embodiment of the light-emitting unit will be described with reference to the accompanying drawings.

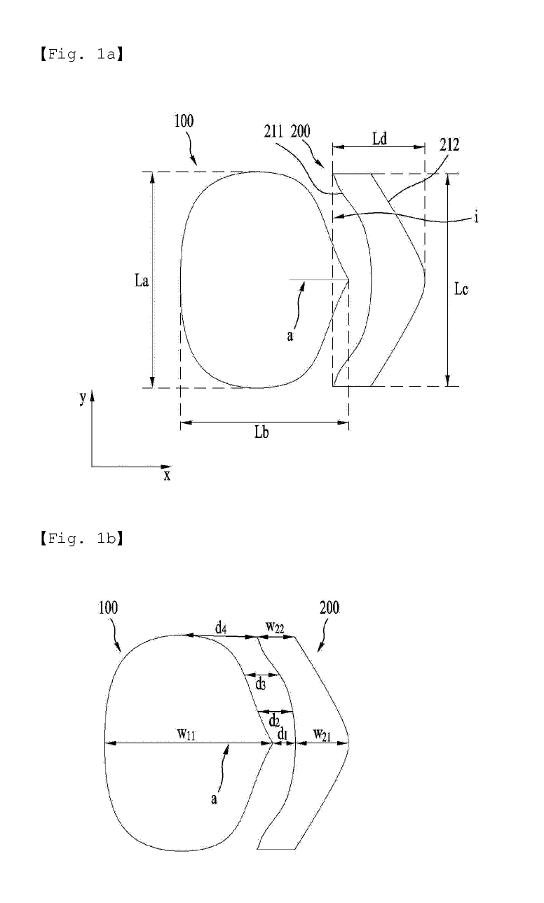

FIGS. 1a and 1b are plan views illustrating an embodiment of the light-emitting unit.

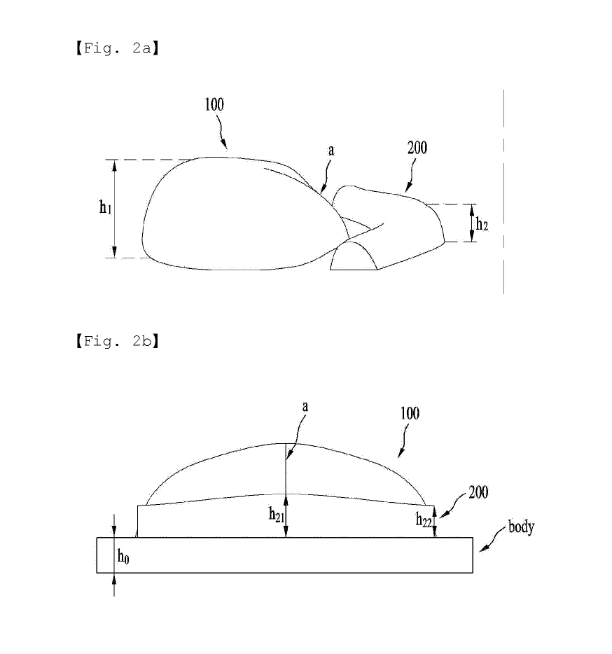

In the light-emitting unit according to the embodiment, a refractor 100 and a reflector 200 may be spaced apart from each other. The refractor 100 and the reflector 200 may be disposed on a body. The body will be described below in detail with reference to FIG. 2b and the like.

In FIG. 1a, the refractor 100 may be configured such that the length La thereof in the y-axis direction, which is a second-axis direction, is greater than the length Lb thereof in the x-axis direction, which is a first-axis direction. For example, the length La of the refractor 100 in the y-axis direction may be greater than the length Lb in the x-axis direction, but may be smaller than 1.5 times the length Lb. In addition, the reflector 200 may be configured such that the length Ld thereof in the first-axis direction is smaller than the length Lb of the refractor 100 in the first-axis direction and such that the length Lc thereof in the second-axis direction is equal to or greater than the length La of the refractor 100 in the second-axis direction. When the length Lc of the reflector 200 in the second-axis direction is smaller than the length La of the refractor 100 in the second-axis direction, some of the light emitted from the refractor 100 may not be reflected on the reflector 200, but may proceed to the right side of the reflector 200 in FIG. 1a, which may result in deterioration in luminous efficacy.

The right end of the refractor 100 may overlap a virtual line i, which interconnects opposite ends of the reflector 200, or may be disposed at the right side of the virtual line i as illustrated in FIG. 1a.

The width w11 of the refractor 100 in the first-axis direction in FIG. 1b may be equal to the length Lb of the refractor 100 in the first-axis direction in FIG. 1a.

The central area of the refractor 100 may protrude to the right side in FIG. 1a, and the central area of the reflector 200 may protrude to the right side in FIG. 1a. In addition, each of the refractor 100 and the reflector 200 may be symmetrical in the vertical direction, i.e. in the y-axis direction, about the center line in the horizontal direction in FIG. 1a. Here, the center line may be the extension line of “a”.

Assuming that the boundary surface of the reflector 200 that faces the refractor 100 is referred to as a first surface 211 and the boundary surface that faces the first surface is referred to as a second surface 212, the curvature of the first surface 211 and the curvature of the second surface 212 may differ from each other.

100% of the light discharged from the refractor 100 may not be reflected on the first surface 211, but some of the light may be reflected on the second surface 212. Thus, when the first surface 211 and the second surface 212 have different curvatures, light rays introduced into the first surface 211 and the second surface 212 in different directions may be efficiently reflected, which may increase the overall luminous efficacy of the light-emitting unit.

In addition, the reflector 200 may have the largest width W21 in the central area thereof, and for example, the width W21 may be 3.05 mm. The width W₂₂ in the edge area of the reflector 200 may be smaller than the width W21 in the central area described above, and may be, for example, 2.05 mm. The width of the reflector 200 may not be continuously reduced from the width W21 in the central area to the width W22 in the edge area, but may be increased in a certain area. For example, at least one area, which has a width that is smaller than the width W21 in the central area of the reflector 200 but is greater than the width W22 in the edge area, may be present between the central area and the edge area of the reflector 200, without limitation thereto.

The width W21 in the central area of the reflector 200 may be greater than the width W22 in the edge area, and may range, for example, from 1.33 times to 1.67 times the width W22. Since a large amount of the light discharged from the refractor 100 is directed to the central area of the reflector 200, the width W21 of the central area of the reflector 200 may be greater than the width W22 of the edge area of the reflector 200. When the width W21 of the central area of the reflector 200 is smaller than the width W22 of the edge area, some of the light discharged from the refractor 100 may not be reflected from the reflector 200, but may pass through the reflector 200.

Here, the above-described widths W21 and W22 may be the length of the reflector 200 in the first-axis direction.

The refractor 100 and the reflector 200 are spaced apart from each other, and the distance therebetween may not be constant.

In FIG. 1b, assuming that the area between the refractor 100 and the reflector 200 is referred to as a “spacing”, the spacing may have the smallest width d1 at the center of the area in which the refractor 100 and the reflector 200 face each other and may have the largest width d4 at the edge of the area. In addition, the widths d2 and d3 of the spacing in at least one location of the area between the center and the edge of the area in which the refractor 100 and the reflector 200 face each other may be greater than the width d1 of the spacing at the center, but may be smaller than the width d4 of the spacing at the edge.

For example, referring to FIG. 1b, the widths d1, d2, d3 and d4 at four locations from the center to the edge of the area in which the refractor 100 and the reflector 200 face each other are illustrated. In FIG. 1b, when the distance between the refractor 100 and the reflector 200 is measured several times at the same interval in the vertical direction within a range from the end to the center of the refractor 100 and the reflector 200, there may be present an area in which a magnitude relationship of the four widths is d1<d2<d3<d4, without limitation thereto.

FIG. 2a is a perspective view illustrating the embodiment of the light-emitting unit, and FIG. 2b is a side view of the light-emitting unit in the first-axis direction.

The larger the height h2 of the reflector 200, the larger the amount of the light that is discharged from the refractor 100 is reflected. For example, when the height h1 of the refractor 100 and the height h2 of the reflector 200 are the same, about 18% of the light discharged from the refractor 100 may proceed to the rear surface (the right side of FIG. 2a) of the reflector 200.

In the present embodiment, the height h1 of the refractor 100 may be 1 to 2.5 times the height h2 of the reflector 200. When the height h2 of the reflector 200 is greater than the height h1 of the refractor 100, the overall volume of the light-emitting unit may be increased. When the height h1 of the refractor 100 is greater than 2.5 times the height h2 of the reflector 200, the quantity of light that proceeds to the rear surface of the reflector 200 may exceed 20% of the light discharged from the refractor 100.

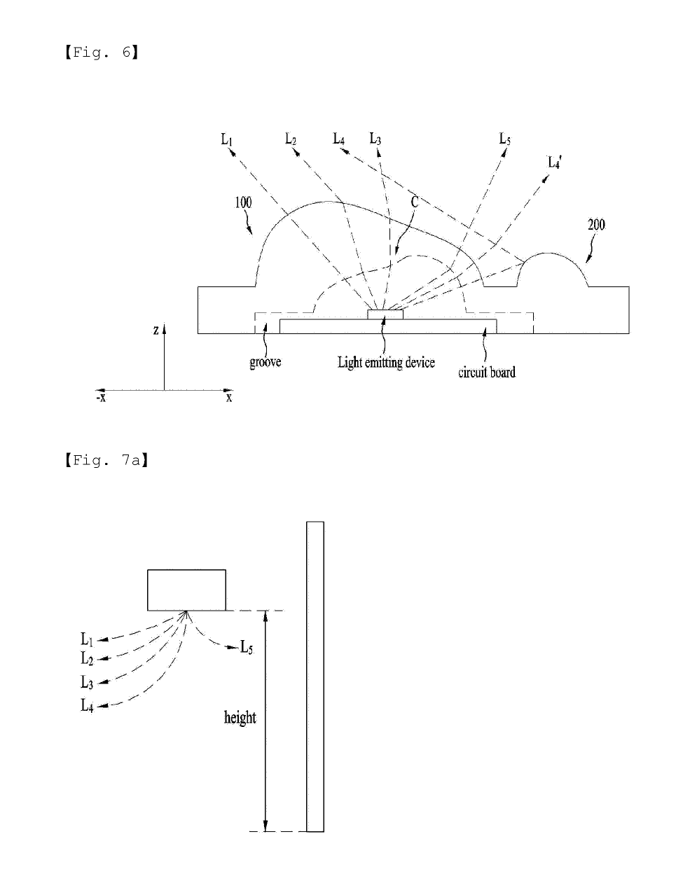

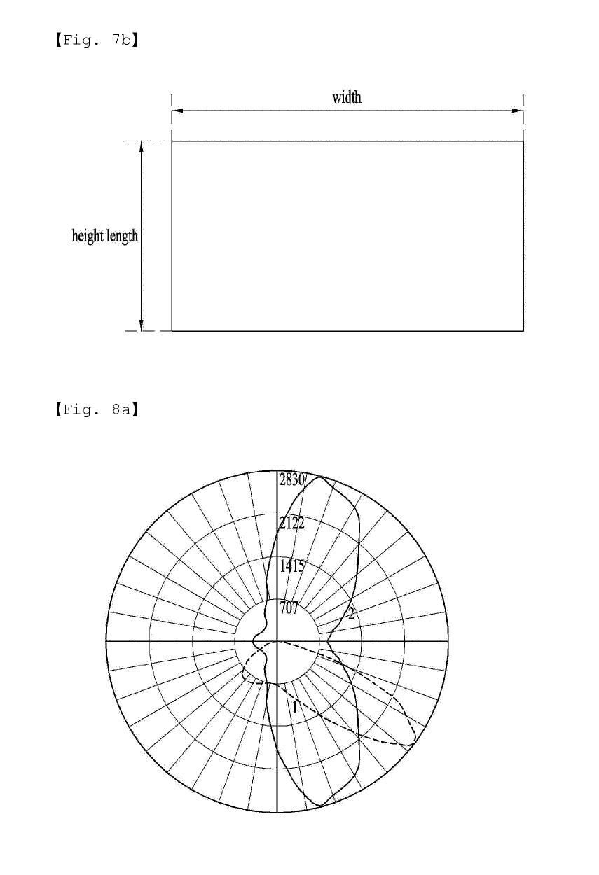

FIGS. 7a and 7b are views illustrating the measured results of back-side illuminance of the light emitted from the light-emitting unit. Light rays L1 to L4 of the light emitted from the light-emitting unit may proceed forward (the left side of FIG. 3a), and a light ray L5 may proceed backward (the right side of FIG. 7a). At this time, when the quantity of light that proceeds backward is within 20% of the total quantity of light, the average illuminance measured on a screen may be 10 lux or less. The screen may be 16 m in width and 6 m in height, and the light-emitting unit may be located at the height of 5 m. In addition, the screen may be spaced apart from the light-emitting unit by 1 m.

When the quantity of the light that proceeds to the rear surface of the reflector 200, for example, the light that proceeds along the path of the light ray L5 of FIG. 6 exceeds 20% of the total quantity of light, the illuminance on the rear vertical surface of the light-emitting unit (the right side of FIG. 2a) may increase and the illuminance on the front surface of the light-emitting unit (the left side of FIG. 2a) may decrease. In FIG. 2b, the reflector 200 may have a larger height h21 at the center than the height h22 at the edge thereof, and for example, the height h21 at the center may be 1.2 times to 2 times the height h22 at the edge. Since a larger amount of the light discharged from the refractor 100 is directed to the central area than to the edge area of the reflector 200, light reflection efficiency may be increased when the reflector 200 is the highest at the center thereof. When the height h21 at the center is less than 1.2 times the height h22 at the edge, the efficiency with which light rays directed from a light-emitting device to the central area are reflected may be reduced. When the height h21 exceeds 2 times the height h22, a larger amount of light is reflected from the centra area than from the edge area, which may cause light to be concentrated on a specific area, making it impossible to achieve uniform light distribution and resulting in an increase in the size of the light-emitting unit.

In addition, the height h0 of the body may be smaller than the height h21 of the reflector 200 at the center, but may be larger than the height h22 of the reflector 200 at the edge. For example, the height h0 of the body may range from 1.5 mm to 5.0 mm. When the height h0 of the body is smaller than 1.5 mm, the body may be easily bent by external force. When the height h0 is larger than 5.0 mm, the quantity of light to be absorbed by the body may be increased.

The surface of the refractor 100 forms a light-emitting portion, and may include a curved surface. Here, the surface of the refractor 100 contains a discontinuous line a of curvature in the area thereof that faces the reflector 200. The aforementioned discontinuous line a may be disposed on the refractor 100 in the height direction. In addition, the reflector 200 may have the largest height h21 in the area thereof that faces the discontinuous line a. The height h2 of the reflector in FIG. 3 may be the same as the height h21 of the reflector 200 in the area that faces the discontinuous line a in FIG. 2b.

The discontinuous line a described above may be pointed in the peripheral direction of the refractor 100, which may reduce the quantity of light that is discharged from a light-emitting device, which will be described later, and is introduced into the refractor 100 to thereby be directed to the reflector 200.

FIG. 3 is a cross-sectional view of the light-emitting unit in the second-axis direction.

A groove is formed inside the body and the refractor 100. The area in which a circuit board, which will be described later, is to be disposed may be referred to as a first groove, and the area in which a light-emitting device is to be disposed above the first groove may be referred to as a second groove.

At least a portion of the first groove may be aligned with the refractor 100 and the reflector 200, and the second groove may be aligned only with the refractor 100. Here, the expression “A is aligned with B” means that at least a portion of A and B may vertically overlap each other.

Assuming that the surface of the refractor that corresponds to the height hi of the refractor is the “highest point” of the refractor and that the surface of the second groove that corresponds to the height Ch2 of the second groove is the “highest point” of the second groove, the highest point of the refractor 100 and the highest point of the second groove may be disposed with the central area of the refractor interposed therebetween. That is, the highest point of the refractor 100 and the highest point of the second groove may be disposed opposite each other about the central area of the refractor. Here, the “central area” of the refractor is illustrated as “Center” in FIG. 3, and may correspond to the center of the width of the refractor 100 designated by “W11”.

In FIG. 3, the smallest thickness t₀ of the refractor 100 in the area close to the second groove may be 1 mm or more. When the thickness is thinner, it may be difficult to manufacture the refractor using injection molding and to achieve desired light distribution.

Since the light discharged from a light-emitting device is introduced into the refractor 100 through the surface of the second groove, the second groove may be a light introduction portion and the upper surface of the second groove may be a light introduction surface.

The light introduction surface described above may be a curved surface, and the curved surface may have at least two curvatures. In FIG. 3, the boundary between areas of the upper surface of the second groove, which is the light introduction surface, having different curvatures is designated by “C”. As illustrated in FIG. 6, the light emitted from a light-emitting device may proceed to the refractor 100 through the light introduction surface, which is the surface of the second groove.

When the surface of the second groove is the light introduction surface, most of the light discharged from a light-emitting device may be introduced into the area of the surface of the second groove that is not close to the first groove, and a small quantity of light may be introduced into the area of the second groove that is close to the first groove.

The length Cw1 of the first groove may be greater than the height Ch1. Here, one end d1 of the first groove may be aligned with or be located inward of the edge of the refractor 100, and the other end d2 may be aligned with the reflector 200.

The length Cw2 of the second groove may be greater than the height Ch2. Here, one end e1 and the other end e2 of the second groove may be aligned with the refractor 100. That is, one end e1 and the other end e2 of the second groove may be located inward of the edge of the refractor 100. When the ends e1 and e2 of the second groove are aligned with or located outward of the edge of the refractor 100, some of the light that is discharged from a light-emitting device and is introduced into the light introduction surface of the second groove may not be directed to the refractor 100.

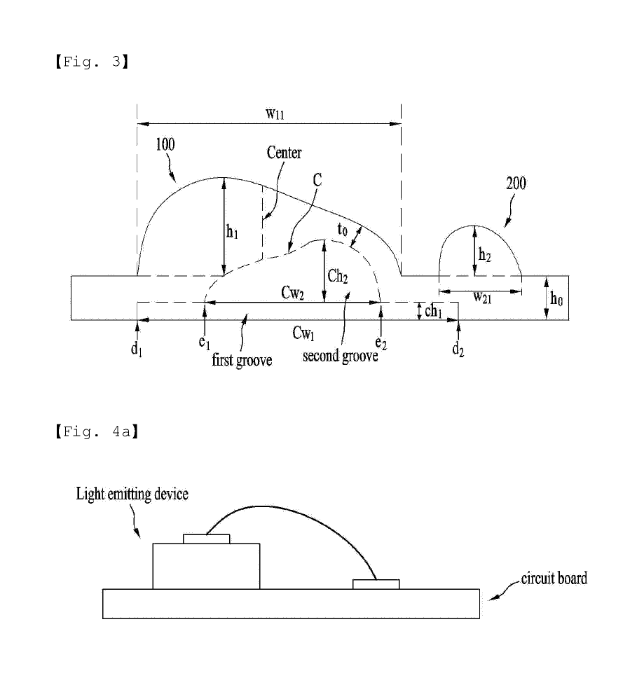

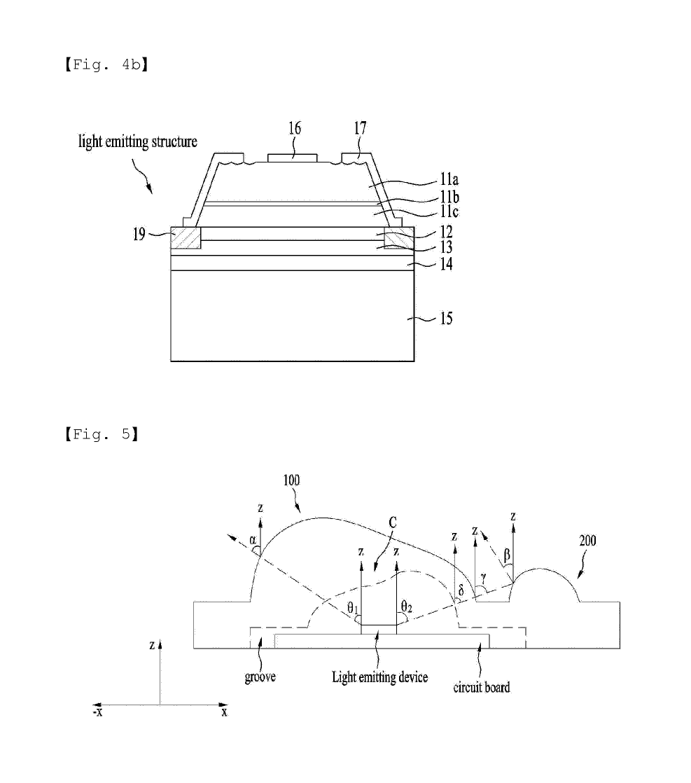

FIG. 4a is a view illustrating an embodiment of a light source module disposed in the light-emitting unit, and FIG. 4b is a view illustrating an embodiment of a light-emitting device of FIG. 4a.

The light source module may include a circuit board and a light-emitting device. The circuit board may be a printed circuit board, or a flexible circuit board, for example.

The light-emitting device may be a light-emitting diode, and for example, may be a vertical light-emitting device, a horizontal light-emitting device, or a flip-chip-type light-emitting device. In FIG. 4b, a vertical light-emitting device is illustrated by way of example.

In the light-emitting device, a bonding layer 14, a reflective layer 13, and an ohmic layer 12 may be disposed on a support substrate 15, a light-emitting structure may be disposed on the ohmic layer 12, and a channel layer 19 may be disposed in the edge area below the light-emitting structure.

The support substrate 15 may be a base substrate and may 1e realized using at least one selected from among copper (Cu), gold (Au), nickel (Ni), molybdenum (Mo), copper-tungsten (Cu—W), and the like. In addition, the support substrate 15 may be realized using, for example, Si, Ge, GaAs, ZnO, SiC, SiGe, Ga₂O₃, or GaN.

The bonding layer 14 may be disposed on the support substrate 15. The bonding layer 14 may bond the reflective layer 13 to the support substrate 15. The bonding layer 14 may contain at least one selected from among, for example, Ti, Au, Sn, Ni, Cr, Ga, In, Bi, Cu, Ag, and Ta.

The reflective layer 13 may be formed on the bonding layer 14. The reflective layer 13 may be formed of a material having excellent reflection characteristics, for example, silver (Ag), nickel (Ni), aluminum (Al), rubidium (Rh), palladium (Pd), iridium (Ir), ruthenium (Ru), magnesium (Mg), zinc (Zn), platinum (Pt), gold (Au), hafnium (Hf), and selective combinations thereof, or may be formed in multiple layers using the metal material described above and a light-transmitting conductive material such as, for example, IZO, IZTO, IAZO, IGZO, IGTO, AZO, or ATO. In addition, the reflective layer 13 may be a stack of IZO/Ni, AZO/Ag, IZO/Ag/Ni, AZO/Ag/Ni, or. the like, without limitation thereto.

The ohmic layer 12 may be formed on the reflective layer 13. The ohmic layer 12 may be in ohmic contact with the lower surface of the light-emitting structure, and may be configured as a layer or a plurality of patterns. The ohmic layer 12 may be formed by selectively using a light-transmitting electrode layer and a metal, and may be formed in a single layer or in multiple layers using one or more selected from among indium tin oxide (ITO), indium zinc oxide (IZO), indium zinc tin oxide (IZTO); indium aluminum zinc oxide (IAZO), indium gallium zinc oxide (IGZO), indium gallium tin oxide (IGTO), aluminum zinc oxide (AZO), antimony tin oxide (ATO), gallium zinc oxide (GZO), IrOx, RuOx, RuOx/ITO, Ni, Ag, Ni/IrOx/Au, and Ni/IrOx/Au/ITO.

The support substrate 15, the bonding layer 14, the reflective layer 13, and the reflective layer 12 may form a first electrode, and may supply current to the light-emitting structure.

The channel layer 19 may be disposed between the first electrode and the light-emitting structure. The channel layer 19 may be disposed in the edge area under the light-emitting structure, and may be formed of a light-transmitting material such as, for example, a metal oxide, a metal nitride, a light-transmitting nitride, or a light-transmitting oxide, or may be formed as a light-transmitting insulation layer. For example, the channel layer 19 may be formed using one selected from among indium tin oxide (ITO), indium zinc oxide (IZO), IZO nitride (IZON), indium zinc tin oxide (IZTO), indium aluminum zinc oxide (IAZO), indium gallium zinc oxide (IGZO), indium gallium tin oxide (IGTO), aluminum zinc oxide (AZO), antimony tin oxide (ATO), gallium zinc oxide (GZO), SiO₂, SiOₓ, SiOₓN_{y}, Si₃N₄, Al₂O₃ and TiO₂.

The light-emitting structure may be disposed on the first electrode. The light-emitting structure includes a first conductive semiconductor layer 11a, an active layer 11b, and a second conductive semiconductor layer 11c.

The first conductive semiconductor layer 11a may be formed using, for example, group III-V or II-VI compound semiconductors, and may be doped with a first conductive dopant. The first conductive semiconductor layer 11a may be formed of a semiconductor material having a composition equation of AlₓIn_{y}Ga_{(1-x-y)}N (0≤x≤1, 0≤y≤1, 0≤x+y≤1), for example, any one or more selected from among AlGaN, GaN, InAlGaN, AlGaAs, GaP, GaAs, GaAsP, and AlGaInP.

When the first conductive semiconductor layer 11a is an n-type semiconductor layer, the first conductive dopant may include an n-type dopant such as, for example, Si, Ge, Sn, Se, or Te. The first conductive semiconductor layer 11a may be formed in a single layer or in multiple layers, without limitation thereto.

The active layer 11b may be disposed between the first conductive semiconductor layer 11a and the second conductive semiconductor layer 11c, and may include any one of a single well structure, a multi-well structure, a single quantum well structure, a multi quantum well (MOW) structure, a quantum dot structure, and a quantum line structure.

The active layer 11b may have any one or more pair structures of a well layer and a barrier layer using group III-V compound semiconductors, for example, AlGaN/AlGaN, InGaN/GaN, InGaN/InGaN, AlGaN/GaN, InAlGaN/GaN, GaAs(InGaAs)/AlGaAs, and GaP(InGaP)/AlGaP, without limitation thereto.

The well layer may be formed of a material that has a smaller energy band gap than the energy band gap of the barrier layer.

The second conductive semiconductor layer 11c may be formed using compound semiconductors. The second conductive semiconductor layer 11c may be formed of, for example, group III-V or II-VI compound semiconductors, and may be doped with a second conductive dopant. The second conductive semiconductor layer 11c may be formed of a semiconductor material having a composition equation of InₓAl_{y}Ga_{(1-x-y)}N (0≤x≤1, 0≤y≤1, 0≤x+y≤1), for example, any one or more selected from among AlGaN, GaN, AlInN, AlGaAs, GaP, GaAs, GaAsP, and AlGaInP.

When the second conductive semiconductor layer 11c is a p-type semiconductor layer, the second conductive dopant may be a p-type dopant such as, for example, Mg, Zn, Ca, Sr, or Ba. The second conductive semiconductor layer 11c may be formed in a single layer or in multiple layers, without limitation thereto.

Although not illustrated, an electron blocking layer may be disposed between the active layer 11b and the second conductive semiconductor layer 11c. The electron blocking layer may have the structure of a super-lattice. For example, the super-lattice may be formed by disposing AlGaN doped with a second conductive dopant and alternately disposing a plurality of GaN layers having different composition rates of aluminum, without limitation thereto.

The surface of the first conductive semiconductor layer 11a may have a pattern such as, for example, convex and concave portions in order to increase light extraction efficiency. A second electrode 16 is disposed on the surface of the first conductive semiconductor layer 11a. As illustrated, the surface of the first conductive semiconductor layer 11a, on which the second electrode 16 is disposed, may or may not be patterned along the surface of the first conductive semiconductor layer 11a. The second electrode 16h may be formed in a single layer or in multiple layers using at least one selected from among aluminum (Al), titanium (Ti), chrome (Cr), nickel (Ni), copper (Cu), and gold (Au).

A current blocking layer (not illustrated) may be disposed under the light-emitting structure so as to be aligned with the second electrode 16. The current blocking layer may be formed using an insulating material. The current blocking layer may cause the current supplied from the direction of the support substrate 15 to be uniformly supplied to the entire area of the second conductive semiconductor layer 11c. The current blocking layer (not illustrated) may be disposed in the area that vertically overlaps the second electrode 16, without limitation thereto.

A passivation layer 17 may be formed around the light-emitting structure. The passivation layer 17 may be formed of an insulating material, and the insulating material may include a non-conductive oxide or nitride. In one example, the passivation layer 180 may be configured as a silicon oxide (SiO₂) layer, a nitride oxide layer, or an aluminum oxide layer.

The light-emitting module may be inserted into the light-emitting unit described above so as to form an emission unit. Specifically, at least a portion of the light-emitting device module may be inserted into the light-emitting unit.

FIG. 5 is a view illustrating the optical path of an emission unit, and FIG. 6 is a view illustrating the distribution of light emitted from the emission unit.

Light is discharged from the light-emitting element to have a view angle within a predetermined range. In FIG. 5, the light discharged from a light-emitting device mat form angles θ1 and θ2 relative to the z-axis direction, which is the vertical direction. For example, the view angle of light discharged from the light-emitting device may range from 90 degrees to 120 degrees, and each of the angles θ1 and θ2 may range from 45 degrees to 60 degrees, without limitation thereto. Here, the z-axis direction may be orthogonal to the x-axis direction of FIG. 5 and to the y-axis direction of FIG. 1a. In addition, when a lens or any other material is disposed on the light-emitting device, the view angle of light discharged from the light-emitting device may be changed.

In the following description of FIG. 5, it is assumed that the -x-axis direction is a first direction and the x-axis direction is a second direction. Here, the z-axis direction described below may be the direction that is orthogonal to the emission surface of the light-emitting device.

It may be assumed that the angle between the z-axis direction and the light that is discharged from the light-emitting device and introduced into the refractor 100 to thereby proceed from the surface of the refractor 100 in the first direction is “α”, the angle between the z-axis direction and the light that is discharged from the light-emitting device and proceeds in the second direction to thereby be introduced into the refractor 100 from the surface of the second groove is “δ”, the angle between the z-axis direction and the light that is discharged from the light-emitting device and proceeds in the second direction to thereby be introduced into the refractor 100 from the surface of the second groove and thereafter be discharged from the surface of the refractor 100 in the second direction is “ [symbol] ”, and the angle between the z-axis and the light that is discharged in the second direction and reflected from the surface of the reflector 200 to thereby proceed in the first direction is “β”.

Here, assuming that the index of refraction of a material that constitutes the refractor 100 and the reflector 200 is “n”, the angle between the z-axis and the light that proceeds inside and outside the light source unit may satisfy the following Equations 1, 2 and 3, in which case the optical paths may be L1 to L4 of FIG. 6.

(n×cos α)−(n×cos β)>0 Equation 1

(n×cos [symbol] )−(n×cos [symbol] )>0 Equation 2

(n×cos δ)−(n×cos [symbol] )>0 Equation 3

When Equation 1 is satisfied, as illustrated, the light ray L4 is reflected from the reflector 200 so that the light rays L1 and L4 cross each other. When Equation 1 is not satisfied, the light ray L4 may proceed in the x-axis direction, or in a direction intermediate to the x-axis direction and the ?x-axis direction.

When Equation 2 is satisfied, the light ray L4 may proceed in opposite directions before and after being reflected by the reflector as illustrated. However, when Equation 2 is not satisfied, since the angle at which light is introduced into the reflector 200 may differ from that of the light ray L4, some of the light reflected from the reflector 200 may be directed in the x-axis direction, and may join the light ray L5. Thus, the quantity of light directed in the x-axis direction may be increased and may exceed 20% of the total quantity of light.

When Equation 3 is satisfied, the light in the x-axis direction may proceed in the -x-axis direction due to the effect of the reflector, similar to the light ray L4. However, when Equation 3 is not satisfied, the direction of light is changed as represented by a light ray L4′, whereby the quantity of light that proceeds in the x-axis direction may be increased.

The refractor 100 and the reflector 200 may be formed of polycarbonate.

When the path of light discharged from the light-emitting device satisfies Equation 1 to Equation 3 described above, most light, i.e. the light rays L1, L2, L3 and L4 may proceed in the second direction (to the left side of FIG. 6), and an extremely small quantity of light, i.e. the light ray L5 may proceed in the first direction (to the right side of FIG. 6).

Hereinafter, the angle θ1 and θ2 between the z-axis direction, which is the vertical direction, and the light discharged from the light-emitting device will be described by way of example. For example, when the view angle of light discharged from the above-described light-emitting device is below 90 degrees, for example, 80 degrees, each of the angle θ1 and θ2 between the z-axis direction, which is the vertical direction, and the light discharged from the light-emitting device in FIG. 5 may be 40 degrees.

At this time, the value corresponding to the above-described Equation 1 is 0.7749−0.6450>0 and the value corresponding to Equation 3 is 1.088−0.6450>0, but the value corresponding to Equation 2 may be less than 0. As described above, the light ray L4 may proceed in the x-axis direction, or the magnitude of the light ray L5 may be increased so as to exceed 20% of the total quantity of light.

When the view angle of light discharged from the above-described light-emitting device is 90 degrees, each of the angle θ1 and θ2 between the z-axis direction, which is the vertical direction, and the light discharged from the light-emitting device in FIG. 5 may be 45 degrees.

At this time, the value corresponding to the above-described Equation 1 is 0.7761−0.1250>0, the value corresponding to Equation 2 is 0.4789×0.1250>0, and the value corresponding to Equation 3 may be 0.8995−0.4789>0. Thus, most light proceeds in the direction designated by L1 to L4 as illustrated in FIG. 6 and a small quantity of light proceeds in the direction designated by L4′ so that the quantity of light that proceeds in the direction designated by L4 and L5 may be within 20% of the total quantity of light discharged from the light-emitting unit.

When the view angle of light discharged from the above-described light-emitting device is 100 degrees, each of the angle θ1 and θ2 between the z-axis direction, which is the vertical direction, and the light discharged from the light-emitting device in FIG. 5 may be 50 degrees.

At this time, the value corresponding to the above-described Equation 1 is 0.7796−0.6210>0, the value corresponding to Equation 2 is 0.3654×0.6210>0, and the value corresponding to Equation 3 may be 0.7280−0.3654>0. Thus, most light proceeds in the direction designated by L1 to L4 as illustrated in FIG. 6, and a small quantity of light proceeds in the direction designated by L4′ so that the quantity of light that proceeds in the direction designated by L4 and L5 may be within 20% of the total quantity of light discharged from the light-emitting unit.

When the view angle of light discharged from the above-described light-emitting device is 110 degrees, each of the angle θ1 and θ2 between the z-axis direction, which is the vertical direction, and the light discharged from the light-emitting element in FIG. 5 may be 55 degrees.

At this time, the value corresponding to the above-described Equation 1 is 0.7801−0.5791=0.3346>0, the value corresponding to Equation 2 is 0.3341×0.5791=0.1452>0, and the value corresponding to Equation 3 may be 0.6314−0.3341=0.2086>0. Thus, most light proceeds in the direction designated by L1 to L4 as illustrated in FIG. 6, and a small quantity of light proceeds in the direction designated by L4′ so that the quantity of light that proceeds in the direction designated by L4 and L5 may be within 20% of the total quantity of light discharged from the light-emitting unit.

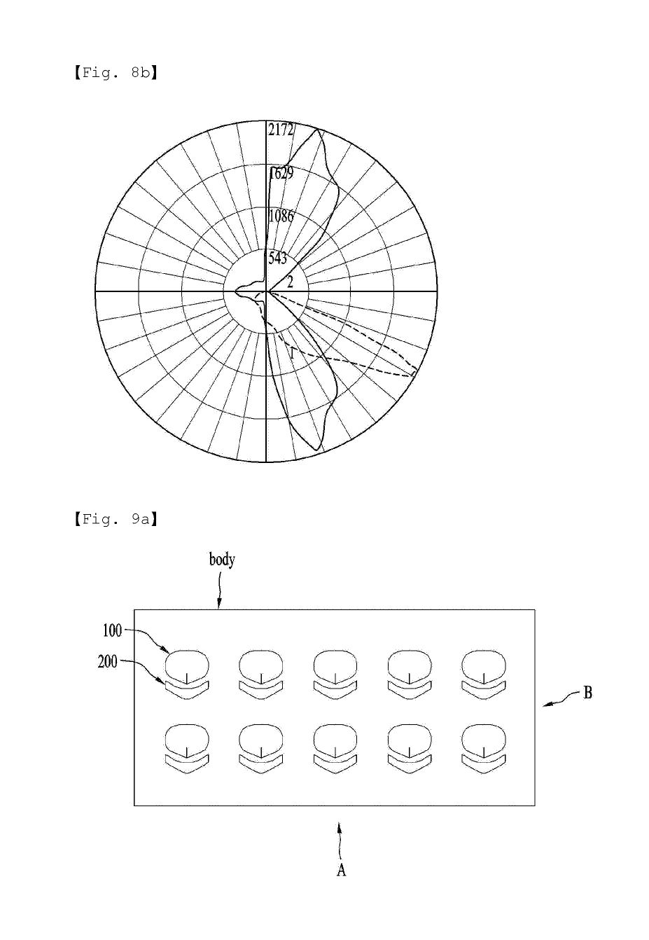

FIGS. 8a and 8b are views illustrating the distribution of light emitted from the light source unit. In FIGS. 8a and 8b, blue represents the distribution of light in the x-axis direction of FIG. 5, the right side is the first direction, the left side is the second direction, and red represents the distribution of light in the y-axis direction, although not illustrated in FIG. 5.

In FIG. 8a, the index of refraction n of the refractor may be 1.589, a is about 60.8 degrees, βis about 82.1 degrees, [symbol] is about 77.2 degrees, and δ is about 10.2 degrees. At this time, (n×cos α) may be 0.7749, cos α may be 0.488, (n×cos β) may be 0.2196, cos β may be 0.138, (n×cos [symbol] ) may be 0.3533, cos [symbol] may be 0.222, and (n×cos δ) may be 0.5384, cos δ may be 0.339. In addition, the value corresponding to the above-described Equation 1 is 0.7749−0.2196=0.5553>0, the value corresponding to Equation 2 is 0.3533×0.2196=0.0776>0, and the value corresponding to Equation 3 may be 0.5384−0.3533=0.1851>0.

In FIG. 8b, the index of refraction n of the refractor may be 1.589, α is about 60.8 degrees, β is about 73.9 degrees, [symbol] is about 80.0 degrees, and δ is about 10.2 degrees. At this time, (n×cos α) may be 0.7749, cos α may be 0.488, (n×cos β) may be 0.4403, cos β may be 0.277, (n×cos [symbol] ) may be 0.3298, cos [symbol] may be 0.208, and (n×cos δ) may be 0.5384, cos δ may be 0.339. In addition, the value corresponding to the above-described Equation 2 is 0.7749−0.4403=0.3346>0, the value corresponding to Equation 2 is 0.3298×0.4403=0.1452>0, and the value corresponding to Equation 3 may be 0.5384−0.3298=0.2086>0.

In the embodiment illustrated in FIGS. 8a and 8b, the light that proceeds in the y-axis direction may be uniformly distributed, and most of the light that proceeds in the x-axis direction may be distributed in the first direction.

Thus, when the light source unit including the light-emitting unit described above is used, it is possible to significantly reduce the quantity of light that proceeds in the second direction (the house side) so that most of the light is transferred in the first direction (the street side). When the light source unit is used in, for example, a street lighting apparatus, assuming that the first direction is the street side and the second direction is the house side, it is possible to refract a larger amount of light to the street side so that the quantity of light directed to the house side is reduced.

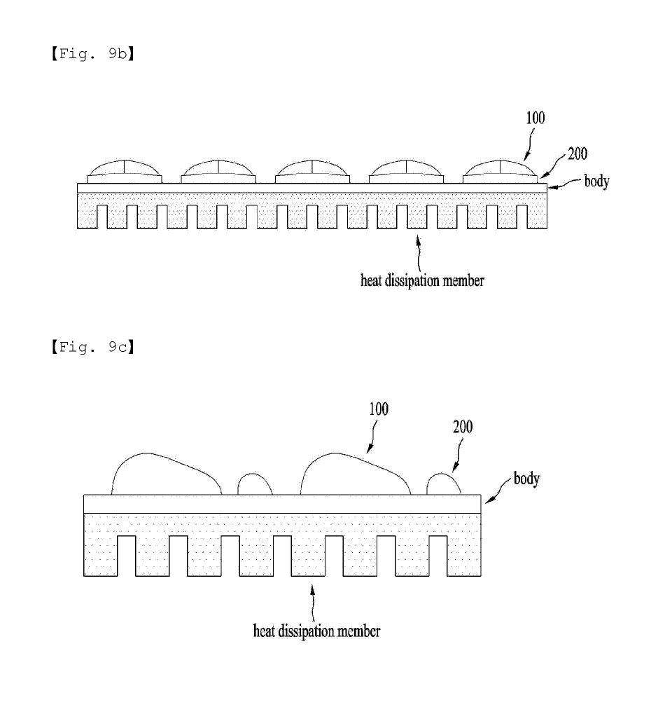

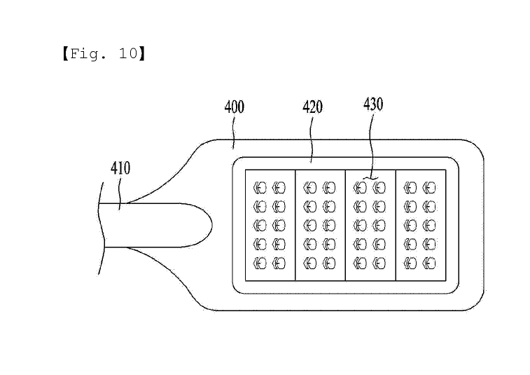

FIGS. 9a to 9c are views illustrating a light source unit in which the light-emitting unit described above is provided in a plural number.

In FIG. 9a, ten light-emitting units are disposed on a single body, and each light-emitting unit includes the refractor 100 and the reflector 200, and thus may have substantially the same concrete shape as that in the above-described embodiment. The light-emitting units may be disposed in two columns and five rows, but may be disposed in different ways.

FIGS. 9b and 9c are views illustrating the light source unit of FIG. 9a viewed from the “A” direction and the “B” direction respectively. In FIGS. 9b and 9c, a heat dissipation member may be disposed under the body and may come into contact with the body, or may be connected to a lead frame, which is connected to the light-emitting element, although not illustrated.

FIG. 10 is a view illustrating an embodiment of a lighting apparatus in which the light source unit described above is disposed. The illustrated light source is used in a street-lighting apparatus and is configured such that a groove 420 is formed in a housing 400 and four light source units 430 are disposed in the groove 420. The shape of the groove 420 or the number or arrangement of light source units 430 are not limited to the illustration, and the housing 400 may include a connector 410 provided on one surface thereof, which may supply power from an external source to the light source units 430, or may be connected to a support member (not illustrated), which supports the housing 400.

In FIG. 10, the side of the connector 410 may be the house side and the right side may be the street side.

The lighting apparatus of FIG. 10 may be used as a security light or any other lighting apparatus, in addition to being used as a streetlight on the street.

Although the embodiments have been described above in detail with reference to the accompanying drawings, it will be apparent to those skilled in the art that the embodiments described above is not limited to the embodiments described above, and various substitutions, modifications, and alterations may be devised within the spirit and scope of the embodiments. Accordingly, various embodiments disclosed here are not intended to limit the technical sprit of the disclosure, and the scope of the technical sprit of the present invention is not limited by the embodiments. Accordingly, the disclosed embodiments are provided for the purpose of description and are not intended to limit the technical scope of the disclosure, and the technical scope of the disclosure is not limited by the embodiments. The range of the disclosure should be interpreted based on the following claims, and all technical ideas that fall within the range equivalent to the claims should be understood as belonging to the scope of the disclosure

### INDUSTRIAL APPLICABILITY

A light-emitting unit and a light source unit having the same according to the embodiment may be used in, for example, a street-lighting apparatus.

1. A light-emitting unit comprising;
a refractor disposed on a body;
a reflector disposed on the body and spaced apart from the refractor; and
a groove having at least a portion disposed inside the body and the refractor, wherein the refractor has a height ranging from 1 to 2.5 times a height of the reflector, and
wherein the refractor and the reflector have a space therebetween, and the space has a smallest width at a center of an area in which the refractor and the reflector face each other and a largest width at an edge of the area.

2. The unit according to claim 1, wherein the groove includes a first groove and a second groove above the first groove, and at least a portion of the first groove is aligned with the refractor and the reflector.

3. The unit according to claim 2, wherein the groove includes a first groove and a second groove above the first groove, and the second groove is aligned with the refractor.

4. The unit according to claim 1, wherein the groove includes a first groove and a second groove above the first groove, and a highest point of the refractor and a highest point of the second groove are disposed with a central area of the refractor interposed therebetween.

5. The unit according to claim 1, wherein the groove has an upper surface, a portion of which forms a light introduction surface, and the light introduction surface is a curved surface having at least two curvatures.

6. The unit according to claim 1, wherein the refractor has a surface including a curved surface, and the surface of the refractor has a discontinuous line of curvature in an area thereof that faces the reflector.

7. The unit according to claim 6, wherein the discontinuous line of curvature is disposed in a height direction of the refractor.

8. The unit according to claim 7, wherein the reflector has a largest height in an area thereof that faces the discontinuous line.

9. The unit according to claim 1, wherein the reflector has a largest width in a central area thereof.

10. The unit according to claim 1, wherein the reflector has a largest height in a central area thereof.

11. The unit according to claim 1, wherein the area includes an area disposed between the center and the edge thereof and having a space width that is greater than the width of the space at the center and is smaller than the width of the space at the edge.

12. The unit according to claim 11, wherein the reflector is formed of the same material as the refractor, and has a convex and concave portion formed on a surface thereof in an area that faces the refractor.

13. The unit according to claim 1, wherein the refractor and the reflector have central areas respectively configured to protrude in the same direction.

14. The unit according to claim 1, wherein at least one of the refractor and the reflector is symmetrical about a center line of the refractor.

15. A light-emitting unit comprising;
a refractor disposed on a body;
a reflector disposed on the body and spaced apart from the refractor; and
a groove having at least a portion disposed inside the body and the refractor,
wherein the refractor and the reflector have a space therebetween, and the space has a smallest width at a center of an area in which the refractor and the reflector face each other and a largest width at an edge of the area, and
wherein the reflector includes a first surface facing the refractor and a second surface opposite the first surface, and the first surface and the second surface have different curvatures.

16. The unit according to claim 15, wherein the reflector includes an area in which a width thereof increases and an area in which the width decreases between a central area and an edge area thereof.

17. An emission unit comprising;
a light-emitting unit including a refractor disposed on a body, a reflector disposed on the body and spaced apart from the refractor, and a groove having at least a portion disposed inside the body and the refractor, wherein the refractor has a height of 1 to 2.5 times a height of the reflector, and wherein the refractor and the reflector have a space therebetween, and the space has a smallest width at a center of an area in which the refractor and the reflector face each other and a largest width at an edge of the area; and
a light-emitting device disposed in the groove.

18. The unit according to claim 17, wherein, assuming that an angle between a z-axis orthogonal to an emission surface of the light-emitting device and light that proceeds from a surface of the refractor in a first direction is “α”, an angle between the z-axis and light that is discharged from the light-emitting device and proceeds in a second direction to thereby be introduced into the refractor from a surface of the groove is “δ”, an angle between the z-axis and light that is discharged from the light-emitting device and proceeds in the second direction to thereby be introduced into the refractor from the surface of the groove and thereafter be discharged from a surface of the refractor in the second direction is “γ”, and an angle between the z-axis and light that is discharged in the second direction and reflected from the surface of the reflector to thereby proceed in the first direction is “β”, there is an equation of the form (n×cos α)−(n×cos β)>0.

19. The unit according to claim 18, wherein there is an equation of the form (n×cos δ)−(n×cos γ)>0.

20. The unit according to claim 18, wherein there is an equation of the form (n×cos h)-(n×cos y)>0.
